(19) United States
(12) Patent Application Publication
(10) Pub. No.: US 2005/0245783 A1
(43) Pub. Date: Nov. 3, 2005

(54) Method for stabilization of chromium

(76) Inventor: Keith Edward Forrester, Meredith, NH (US)

Correspondence Address: Keith E. Forrester, 78 Tracy Way, Meredith, NH, 03253, US

(21) Appl. No.: 11/113,517

(22) Filed: Apr. 25, 2005

Related U.S. Application Data
(60) Provisional application No. 60/566,485, filed on Apr. 29, 2004.

(51) Int. Cl. B09B 3/00

(52) U.S. Cl. 588/256

(57) ABSTRACT

This invention provides a method for stabilization of chromium subject to acid and water leaching tests or leach conditions by addition of solution, reducing, precipitating and stabilizing agents such that leaching of chromium is inhibited to desired levels. The resultant material or waste after stabilization is deemed suitable for on-site reuse, off-site reuse or disposal as RCRA non-hazardous waste.

### BACKGROUND OF THE INVENTION

Chromium bearing waste, material, ore, or contaminated soils may be deemed “Hazardous Waste” by the United States Environmental Protection Agency (USEPA) pursuant to 40 C.F.R. Part 261 and also deemed hazardous under similar regulations in other countries such as Japan, Switzerland, Mexico, Australia, Canada, Taiwan, European Countries, India, and China, and deemed special waste within specific regions or states within those countries, if containing designated leachate solution-soluble and/or sub-micron filter-passing particle sized Total Chromium (Cr) above levels deemed hazardous by those country, regional or state regulators. Chromium can often be found in an oxidized state as hexavalent chromium Cr(6), and reduced trivalent state Cr(3).

In the United States, any solid waste or contaminated soil can be defined as Hazardous Waste either because it is “listed” in 40 C.F.R., Part 261 Subpart D, federal regulations adopted pursuant to the Resource Conservation and Recovery Act (RCRA), or because it exhibits one or more of the characteristics of a Hazardous Waste as defined in 40 C.F.R. Part 261, Subpart C. The hazard characteristics defined under 40 CFR Part 261 are: (1) ignitability, (2) corrosivity, (3) reactivity, and (4) toxicity as tested under the Toxicity Characteristic Leaching Procedure (TCLP). 40 C.F.R., Part 261.24(a), contains a list of heavy metals and their associated maximum allowable concentrations. If a heavy metal, such as chromium, exceeds its maximum allowable concentration from a solid waste, when tested using the TCLP analysis as specified at 40 C.F.R. Part 261 Appendix 2, then the solid waste is classified as RCRA Hazardous Waste. The USEPA TCLP test uses a dilute acetic acid either in de-ionized water (TCLP fluid 2) or in de-ionized water with a sodium hydroxide buffer (TCLP fluid 1). Both extract methods attempt to simulate the leachate character from a decomposing trash landfill in which the solid waste being tested for is assumed to be disposed in and thus subject to rainwater and decomposing organic matter leachate combination . . . or an acetic acid leaching condition. Waste containing leachable heavy metals is currently classified as hazardous waste due to the toxicity characteristic, if the level of TCLP analysis is above 0.2 to 100 milligrams per liter (mg/L) or parts per millions (ppm) for specific heavy metals. The TCLP test is designed to simulate a worst-case leaching situation . . . that is a leaching environment typically found in the interior of an actively degrading municipal landfill. Such landfills normally are slightly acidic with a pH of approximately 5±0.5. Countries outside of the US also use the TCLP test as a measure of leaching such as Thailand, Taiwan, Mexico, and Canada. Thailand also limits solubility of Cu and Zn, as these are metals of concern to Thailand groundwater. Switzerland and Japan regulate management of solid wastes by measuring heavy metals and salts as tested by a sequential leaching method using carbonated water simulating rainwater and de-ionized water sequential testing. Additionally, U.S. EPA land disposal restrictions prohibit the land disposal of solid waste leaching in excess of maximum allowable concentrations upon performance of the TCLP analysis. The land disposal regulations require that hazardous wastes are treated until the heavy metals do not leach at levels from the solid waste at levels above the maximum allowable concentrations prior to placement in a surface impoundment, waste pile, landfill or other land disposal unit as defined in 40 C.F.R. 260.10.

Suitable acetic acid leach tests include the USEPA SW-846 Manual described Toxicity Characteristic Leaching Procedure (TCLP) and Extraction Procedure Toxicity Test (EP Tox) now used in Canada. Briefly, in a TCLP test, 100 grams of waste are tumbled with 2000 ml of dilute and buffered or non-buffered acetic acid for 18 hours and then filtered through a 0.75 micron filter prior to nitric acid digestion and final ICP analyses for total “soluble” metals. The extract solution is made up from 5.7 ml of glacial acetic acid and 64.3 ml of 1.0 normal sodium hydroxide up to 1000 ml dilution with reagent water.

Suitable water leach tests include the Japanese leach test which tumbles 50 grams of composited waste sample in 500 ml of water for 6 hours held at pH 5.8 to 6.3, followed by centrifuge and 0.45 micron filtration prior to analyses. Another suitable distilled water CO₂ saturated method is the Swiss protocol using 100 grams of cemented waste at 1 cm³ in two (2) sequential water baths of 2000 ml. The concentration of chromium and salts are measured for each bath and averaged together before comparison to the Swiss criteria.

Suitable citric acid leach tests include the California Waste Extraction Test (WET), which is described in Title 22, Section 66700, “Environmental Health” of the California Health & Safety Code. Briefly, in a WET test, 50 grams of waste are tumbled in a 1000 ml tumbler with 500 grams of sodium citrate solution for a period of 48 hours. The concentration of leached chromium is then analyzed by Inductively-Coupled Plasma (ICP) after filtration of a 100 ml aliquot from the tumbler through a 45 micron glass bead filter.

The present invention provides a method of reducing the solubility of Chromium as hexavalent or trivalent chromium in waste or material. Chromium is controlled by the invention under TCLP, SPLP, CALWET, MEP, rainwater and surface water leaching conditions as well as under regulatory water extraction test conditions as defined by waste control regulations in Thailand, Taiwan, Japan, Canada, Mexico, Switzerland, Germany, Sweden, The Netherlands and under American Nuclear Standards for sequential leaching of wastes by de-ionized water. Unlike the present invention, prior art has focused on reducing solubility of Cr(6) by reduction to Cr(3) followed by pH precipitation control. Chromium Cr(6) reduction in wastewater or water to Cr(3) and pH adjustment for Cr(3) precipitation is taught in standard wastewater and water treatment methods in the field of Sanitary and Environmental Engineering. These previous methods fail to teach optimal Cr(6) reduction method to Cr(3) from solids and fail to teach the need to stabilize Cr(3) into a mineral form resistant to Cr(3) reverting to soluble Cr(6) due to subsequent surface oxidation and pH shift.

U.S. Pat. No. 5,202,033 describes an in-situ method for decreasing Pb TCLP leaching from solid waste using a combination of solid waste additives and additional pH controlling agents from the source of phosphate, carbonate, and sulfates.

U.S. Pat. No. 5,037,479 discloses a method for treating highly hazardous waste containing unacceptable levels of TCLP Pb such as lead by mixing the solid waste with a buffering agent selected from the group consisting of magnesium oxide, magnesium hydroxide, reactive calcium carbonates and reactive magnesium carbonates with an additional agent which is either an acid or salt containing an anion from the group consisting of Triple Superphosphate (TSP), ammonium phosphate, diammonium phosphate, phosphoric acid, boric acid and metallic iron.

U.S. Pat. No. 4,889,640 discloses a method and mixture from treating TCLP hazardous lead by mixing the solid waste with an agent selected from the group consisting of reactive calcium carbonate, reactive magnesium carbonate and reactive calcium magnesium carbonate.

U.S. Pat. No. 4,652,381 discloses a process for treating industrial wastewater contaminated with battery plant waste, such as sulfuric acid and heavy metals by treating the waste waster with calcium carbonate, calcium sulfate, calcium hydroxide to complete a separation of the heavy metals. However, this is not for use in a solid waste situation.

### SUMMARY OF THE INVENTION

The present invention discloses a chromium hexavalent Cr(6) and chromium trivalent Cr(3) stabilization method through a sequenced contact of chromium bearing material or waste with chromium solution additive, hexavalent chromium reducing agent, chromium reduction duration, pH adjustment additive for precipitation of Cr(3) and addition of a stabilizing agent source allowing formation of Cr(3) precipitate into more stable form than simple hydroxide precipitate.

It is anticipated that the method can be used for both reactive compliance and remedial actions as well as proactive leaching reduction means such that generated waste does not exceed hazardous waste criteria. The preferred method would be in-line within the waste production operation, and thus allowed under USEPA regulations (RCRA) as totally enclosed, in-tank or exempt method of TCLP stabilization without the need for a RCRA Part B hazardous waste treatment and storage facility permit.

### DETAILED DESCRIPTION

Environmental regulations throughout the world such as those developed by the USEPA under RCRA and CERCLA require heavy metal bearing waste, contaminated soils and material producers to manage such materials and wastes in a manner safe to the environment and protective of human health. In response to these regulations, environmental engineers and scientists have developed numerous means to control heavy metals, mostly through chemical applications which convert the solubility of the material and waste character to a less soluble form, thus passing leach tests and allowing the wastes to be either reused on-site or disposed at local landfills without further and more expensive control means such as hazardous waste disposal landfills or facilities designed to provide metals stabilization. The primary focus of scientists has been on reducing solubility of heavy metals such as lead, cadmium, chromium, arsenic and mercury, as these were and continue to be the most significant mass of metals contamination in soils. Materials such as chromite mining tailings, wastes such steel smelter slag and ash, chromium plating sludge and chromium contaminated soils are major sources of chromium in our environment. The most water soluble form, and thus most bioavailable form of chromium is hexavalent.

There exists a demand for improved methods of chromium stabilization as a non-hazardous waste and methods that resist the reversion of reduced Cr(3) to oxidize back to the more soluble Cr(6) form. The present invention discloses a chromium hexavalent Cr(6) and chromium trivalent Cr(3) stabilization method through a sequenced contact of chromium bearing material or waste with chromium solution additive, reducing agent, chromium reduction duration, pH adjustment additive for precipitation of Cr(3) and addition of a stabilizing source for Cr(3) precipitate formation into a more stable form such as phosphate apatite mineral.

It is anticipated that the method can be used for RCRA compliance actions such that generated waste does not exceed appropriate TCLP hazardous waste criteria, and under TCLP or CERCLA (Superfund) response where the method is used to treat waste piles or storage vessels previously generated. The preferred method of application of stabilizers would be in-line within the generating source, and thus allowed under RCRA as a totally enclosed, in-tank or exempt method of TCLP stabilization without the need for a RCRA Part B hazardous waste treatment and storage facility permit(s).

The method chemical additives including: solution agents as water, surfactants; pH precipitating agents as portland cement, cement kiln dust, lime kiln dust, hydrate lime, quicklime, magnesium oxides, dolomitic lime; reducing agents as ferrous sulfate, bisulfite; and stabilizing agents as ferrous sulfate, ferric chloride, alum, coagulants, flocculants, sulfides, sulfates, phosphates, iron, chlorides, silicates, and combinations thereof, with the phosphate group including but not limited to wet process amber phosphoric acid, wet process green phosphoric acid, aluminum finishing Coproduct blends of phosphoric acid and sulfuric acid, technical grade phosphoric acid, monoammonia phosphate (MAP), diammonium phosphate (DAP), single superphosphate (SSP), triple superphosphate (TSP), hexametaphosphate (HMP), tetrapotassium polyphosphate, dicalcium phosphate, tricalcium phosphate, monocalcium phosphate, phosphate rock, pulverized forms of all above dry phosphates, and combinations thereof would be selected through laboratory treatability and/or bench scale testing to provide sufficient control of metals solubility and particle transport potential. In certain cases, such as with the use of amber and green phosphoric acid acid, phosphates may embody sulfuric acid, vanadium, iron, aluminum and other complexing agents which could also provide for a single-step formation of complexed heavy metal minerals. The stabilizer and agglomeration agent type, size, dose rate, contact duration, and application means would be engineered for each type of chromium bearing material of waste.

Although the exact stabilization formation molecule(s) are undetermined at this time, it is expected that when water borne or surface active trivalent chromium Cr(3) precipitates at pH levels (about or above 8.0 pH units) come into contact with the mineral stabilizing agents at sufficient reaction time, low TCLP/water soluble compounds form such as a chromium substituted calcium mineral phosphate, twinned mineral, mononuclear layers, substitute or surface bonding, which are less soluble than the Cr(3) precipitate and a more stable matrix which resists reversion to soluble Cr(6).

Examples of suitable mineral stabilizing agents include, but are not limited to Portland cement, alum, sulfates, sulfides, ferric chloride, phosphate fertilizers, phosphate rock, pulverized phosphate rock, calcium orthophosphates, monocalcium phosphate, dicalcium phosphate, tricalcium phosphate, trisodium phosphates, calcium oxide (quicklime), dolomitic quicklime, silicates, sodium silicates, potassium silicates, natural phosphates, phosphoric acids, wet process green phosphoric acid, wet process amber phosphoric acid, black phosphoric acid, merchant grade phosphoric acid, aluminum finishing phosphoric and sulfuric acid solution, hypophosphoric acid, metaphosphoric acid, hexametaphosphate, tertrapotassium polyphosphate, polyphosphates, trisodium phosphates, pyrophosphoric acid, fishbone phosphate, animal bone phosphate, herring meal, bone meal, phosphorites, and combinations thereof. Salts of phosphoric acid can be used and are preferably alkali metal salts such as, but not limited to, trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof.

The amounts of initial solution agents, reducing agents, duration time, precipitating agents and mineral stabilizing agent used, according to the method of invention, depend on various factors including desired solubility reduction potential, desired mineral toxicity, and desired mineral formation relating to toxicological and site environmental control objectives. It has been found that addition of 10% water, 3% ferrous sulfate monohydrate, 24 hours sealed curing, 5% cement kiln dust, and 0.5% dicalcium phosphate by weight of chromium bearing soil was sufficient for TCLP Cr stabilization of the soil to less than the RCRA 5.0 ppm limit and 0.10 ppm TCLP groundwater leaching limit. However, the foregoing is not intended to preclude yet higher or lower usage of solution, reduction, curing, precipitating or stabilizing agent or combinations.

The examples below are merely illustrative of this invention and are not intended to limit it thereby in any way.

### EXAMPLE

Two chromium Cr(6) contaminated soil samples were brought to saturate condition with 10% (wwb soil) DI water, stirred by hand for 10 seconds with 3% (wwb soil) ferrous sulfate monohydrate, allowed to cure at STP for 24 hours under cover, and combined with 5% (wwb soil) cement kiln dust and 0.5% (wwb soil) dicalcium phosphate.

TABLE 1

| Stabilizer Addition | TCLP Cr (ppm) | TCLP Limit (ppm) |
|---|---|---|
| Baseline Sample 1 | 46.00 | 5.0 (Landfill Solids Standard) |
| Treated Sample 1 | 0.23 | 5.0 |
| Baseline Sample 2 | 0.74 | 0.10 (Groundwater Standard) |
| Treated Sample 2 | 0.02 | 0.10 |

The foregoing results in Example 1 readily established the operability of the present process to stabilize Chromium thus reducing leachability and bioavailability. Given the effectiveness of the stabilizing method as presented in the Table 1, it is believed that an amount of the reducing and stabilizing agents equivalent to less than 10% by weight of contaminated soil should be effective.

While this invention has been particularly shown and described with reference to preferred embodiments thereof, it will be understood by those skilled in the art that various changes in form and details may be made therein without departing from the spirit and scope of the invention as defined by the appended claims.

1. A method of reducing the solubility of chromium (6) bearing material, waste, or soils, comprising contacting such material, waste or soils with at least one solution agent, one reducing agent, one pH adjustment and precipitating agent, and one stabilizing agent in an amount effective in reducing the solubility to a level no more than non-hazardous levels as determined in an EPA TCLP test, performed on the stabilized material or waste, as set forth in the Federal Register, vol. 55, no. 126, pp. 26985-26998 (Jun. 29, 1990).

2. The method of claim 1, wherein the solution agent is selected from the group consisting as well water, surfactant amended water, wastewater, industrial process water, stomwater, river water, rainwater, lake water, salt water, ocean water, and sea water.

3. The method of claim 1, wherein the reducing agent is selected from the group consisting of ferrous sulfate and bisulfite.

4. The method of claim 1, wherein the pH adjustment and precipitating agent is selected from the group consisting of lime, Portland cement, quicklime, hydrate lime, cement kiln dust, and lime kiln dust.

5. The method of claim 1, wherein the stabilizing agent is selected from the group consisting of phosphates, sulfates, sulfides, Portland cement, silicates, ferric chloride and mineral complexing agent combinations, wet process amber phosphoric acid, wet process green phosphoric acid, coproduct phosphoric acid solution from aluminum polishing, technical grade phosphoric acid, hexametaphosphate, polyphosphate, calcium orthophosphate, superphosphates, triple superphosphates, phosphate fertilizers, phosphate rock, bone phosphate, fishbone phosphates, tetrapotassium polyphosphate, monocalcium phosphate, monoammonia phosphate, diammonium phosphate, dicalcium phosphate, tricalcium phosphate, trisodium phosphate, salts of phosphoric acid, and combinations thereof.

6. A method of claim 1 wherein reduction of solubility is to a level no more than non-hazardous levels as determined under leach tests required by regulation in countries other than the USA including but not limited to Switzerland, Mexico, Taiwan, Japan, Thailand, China, Canada, Germany.

7. A method of reducing the solubility of chromium (3) bearing material, waste, or soils, comprising contacting such material, waste or soils with at least one solution agent, one pH adjustment and precipitating agent, and one stabilizing agent in an amount effective in reducing the solubility to a level no more than non-hazardous levels as determined in an EPA TCLP test, performed on the stabilized material or waste, as set forth in the Federal Register, vol. 55, no. 126, pp. 26985-26998 (Jun. 29, 1990).

8. The method of claim 7, wherein the solution agent is selected from the group consisting as well water, surfactant amended water, wastewater, industrial process water, stomwater, river water, rainwater, lake water, salt water, ocean water, and sea water.

9. The method of claim 7, wherein the pH adjustment and precipitating agent is selected from the group consisting of lime, Portland cement, quicklime, hydrate lime, cement kiln dust, and lime kiln dust.

10. The method of claim 7, wherein the stabilizing agent is selected from the group consisting of phosphates, sulfates, sulfides, Portland cement, silicates, ferric chloride and mineral complexing agent combinations, wet process amber phosphoric acid, wet process green phosphoric acid, coproduct phosphoric acid solution from aluminum polishing, technical grade phosphoric acid, hexametaphosphate, polyphosphate, calcium orthophosphate, superphosphates, triple superphosphates, phosphate fertilizers, phosphate rock, bone phosphate, fishbone phosphates, tetrapotassium polyphosphate, monocalcium phosphate, monoammonia phosphate, diammonium phosphate, dicalcium phosphate, tricalcium phosphate, trisodium phosphate, salts of phosphoric acid, and combinations thereof.

11. A method of claim 7 wherein reduction of solubility is to a level no more than non-hazardous levels as determined under leach tests required by regulation in countries other than the USA including but not limited to Switzerland, Mexico, Taiwan, Japan, Thailand, China, Canada, Germany.
